(19) United States
(12) Patent Application Publication
(10) Pub. No.: US 2007/0171649 A1
(43) Pub. Date: Jul. 26, 2007

(54) Signage using a diffusion chamber

(75) Inventors: Jack C. Rains JR., Oak Hill, VA (US); Alan W. Geishecker, Woodbridge, VA (US)

Correspondence Address: MCDERMOTT WILL & EMERY LLP, 600 13TH STREET, N.W., WASHINGTON, DC, 20005-3096, US

(73) Assignee: ADVANCED OPTICAL TECHNOLOGIES, LLC

(21) Appl. No.: 11/717,124

(22) Filed: Mar. 13, 2007

Related U.S. Application Data
(63) Continuation-in-part of application No. 10/558,480, filed on Nov. 28, 2005.
(63) Continuation-in-part of application No. 10/832,464, filed on Apr. 27, 2004, now Pat. No. 6,995,355.
Application No. 10/832,464 is a continuation-in-part of application No. 10/601,101, filed on Jun. 23, 2003, now Pat. No. 7,145,125.

(51) Int. Cl. F21V 7/00

(52) U.S. Cl. 362/303; 362/265

(57) ABSTRACT

A signage system to provide advertising and the like. In a first example, the sign includes a cavity in a housing with a diffusely reflective interior surface at the back of the housing and a sign panel at the front of the housing with an aperture for allowing emission of light from the cavity. In still another example, the sign is a channel letter with a clear or translucent sign panel and with light sources mounted on a shelf facing the back of the housing. The light sources preferably use LED's or other solid state devices. Where the light sources emit multiple wavelengths, control of the intensity of emission of the LED light sources determines a spectral characteristic of the light output through the aperture.

### RELATED APPLICATIONS

This application is a continuation-in-part of application Ser. No. 10/558,480 filed Nov. 28, 2005, which is a continuation-in-part of application Ser. No. 10/832,464, now U.S. Pat. No. 6,995,355, which is a continuation-in-part of application Ser. No. 10/601,101 filed Jun. 23, 2003, the disclosures of which are incorporated entirely by reference.

### TECHNICAL FIELD

The present subject matter relates to signs for advertising and to signs having a selectable spectral characteristic of visible light (e.g. a selectable color characteristic), produced by combining selected amounts of light energy of different wavelengths from different sources, using a diffusion chamber. The signs exhibit a diffuse reflectivity to provide light having uniform intensity and illumination when emitted through light transmissive sign panel.

### BACKGROUND

Many luminous lighting applications for signage or indicator lights or the like, would benefit from the emission of visible light having uniform intensity and illumination as well as precisely controlled spectral characteristic of the radiant energy. It has long been known that combining the light of one color with the light of another color creates a third color. For example, the commonly used primary colors red, green and blue of different amounts can be combined to produce almost any color in the visible spectrum. Adjustment of the amount of each primary color enables adjustment of the spectral properties of the combined light stream. Recent developments for selectable color systems have utilized light emitting diodes (LEDs) as the sources of the different light colors.

LEDs were originally developed to provide visible indicators and information displays. For such luminance applications, the LEDs emitted relatively low power. However, in recent years, improved LEDs have become available that produce relatively high intensities of output light. These higher power LEDs, for example, have been used in arrays for traffic lights. Today, LEDs are available in almost any color in the color spectrum. However, even with diffusers over the LED array, the individual LEDs typically appear as individual point sources of light.

Systems are known which combine controlled amounts of projected light from at least two LEDs of different primary colors. Attention is directed, for example, to U.S. Pat. Nos. 6,459,919, 6,166,496 and 6,150,774. Typically, such systems have relied on using pulse-width modulation or other modulation of the LED driver signals to adjust the intensity of each LED color output. The modulation requires complex circuitry to implement. Also, such prior systems have relied on direct radiation or illumination from the individual source LEDs. In some applications, the LEDs may represent undesirably bright sources if viewed directly. Also, the direct illumination from LEDs providing multiple colors of light has not provided optimum combination throughout the field of illumination. In some systems, the observer can see the separate red, green and blue lights from the LEDs at short distances from the fixture, even if the LEDs are covered by a translucent diffuser. Integration of colors by the eye becomes effective only at longer distances.

Another problem arises from long-term use of LED type light sources. As the LEDs age, the output intensity for a given input level of the LED drive current decreases. As a result, it may be necessary to increase power to an LED to maintain a desired output level. This increases power consumption. In some cases, the circuitry may not be able to provide enough light to maintain the desired light output level. As performance of the LEDs of different colors declines differently with age (e.g. due to differences in usage), it may be difficult to maintain desired relative output levels and therefore difficult to maintain the desired spectral characteristics of the combined output. The output levels of LEDs also vary with actual temperature (thermal) that may be caused by difference in ambient conditions or different operational heating and/or cooling of different LEDs. Temperature induced changes in performance cause changes in the spectrum of light output.

U.S. Pat. No. 6,007,225 to Ramer et al. (assigned to Advanced Optical Technologies, L.L.C.) discloses a directed lighting system utilizing a conical light deflector. At least a portion of the interior surface of the conical deflector has a specular reflectivity. In several disclosed embodiments, the source is coupled to an optical integrating cavity and an outlet aperture is coupled to the narrow end of the conical light deflector. This patented lighting system provides relatively uniform light intensity and efficient distribution of light over a field of illumination defined by the angle and distal edge of the deflector. However, this patent does not discuss particular color combinations or effects or signage using a diffusion chamber behind a sign panel.

Hence, when solid state light sources such as LED's are used in signage applications, there is a need for light emerging from the sign panel to have uniform light intensity and distribution. There is also a need that the light sources not be visible to the observer from any point in front of the sign panel. There is also a need to control and effectively maintain a desired energy output level of the light sources and to provide the desired continual spectral character of the combined output as performance of the light sources decrease with age.

### SUMMARY

The signage disclosed herein includes a diffusion chamber and light sources coupled to supply light within the chamber. The light from the light sources is diffusely reflected from a reflective interior surface of the chamber such that the light emitted from the chamber through a light transmissive sign panel is uniform in intensity and illumination.

The light sources for signage disclosed herein can be one or more solid state emitting elements such as LEDs or one or more fixtures comprising a body having an optical cavity, an aperture and one or more solid state emitting elements coupled to the cavity into the diffuser chamber. The fixture may include a deflector to direct light emitted from the cavity through the aperture.

The light sources for use in the signage disclosed herein can include a plurality of light sources emitting light having different colors or wavelengths

The light sources for use in the signage disclosed herein can include a control circuit, coupled to the light sources for adjusting output intensity of radiant energy of each of the sources. Such light sources can be any color or wavelength, but typically include red, green, and blue. The integrating or mixing capability of the optical integrating cavity and/or diffusion chamber serves to project light of any color, including white light, by adjusting the intensity of the various light sources coupled to the diffusion chamber. Intensity control may involve control of amplitude of currents used to drive the respective light sources, or other techniques to control the amount of light generated by the light sources

The signage systems disclosed herein also include a number of control circuits. For example, the control circuitry can comprise a color sensor coupled to detect color distribution in the combined radiant energy. Associated logic circuitry, responsive to the detected color distribution, controls the output intensity of the various LEDs, so as to provide a desired color distribution in the integrated radiant energy. The signage systems disclosed herein may also use a number of “sleeper” LEDs that would be activated only when needed. The logic circuitry would be responsive to the detected color distribution to selectively activate the inactive or “sleeper” LEDs as needed, to maintain the desired color distribution in the combined light.

Other control circuitry includes logic circuitry responsive to temperature, for example to reduce intensity of the source outputs to compensate for temperature increases. The control circuitry may include an appropriate fixture for manually setting the desired spectral characteristic, for example, one or more variable resistors or one or more dip switches, to allow a user to define or select the desired color distribution. Automatic controls also are envisioned.

Still other control circuitry includes a data interface coupled to the logic circuitry for receiving data defining the desired color distribution. Such an interface such as a personal computer, personal digital assistant or the like, would allow input of control data from a separate or even remote light emitting fixtures. A number of the fixtures with such data interfaces may be controlled from a common central location.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A and 1B are cross-sectional views of examples of light emitting fixtures for use in signage applications disclosed herein.

FIG. 2 is an isometric view of an extruded body member, of a fixture having the cross-section of FIG. 1A.

FIG. 3 is a front view of a light emitting fixture for use in a signage application, for example to represent the letter “I.”

FIG. 4 is a front view of a light emitting fixture for use in a signage application, representing the letter “L.”

FIG. 5 is a functional block diagram of the electrical components, of one of the light emitting systems, using programmable digital control logic.

FIG. 6 is a circuit diagram showing the electrical components, of one of the light emitting systems, using analog control circuitry.

FIG. 7 is a diagram, illustrating a number of light emitting systems with common control from a master control unit.

FIG. 8 is a cross-sectional view of another example of a light emitting fixture for signage applications.

FIG. 9 is an isometric view of an extruded section of a fixture having the cross-section section of FIG. 8.

FIG. 10 is a cross-sectional view of another example of a light emitting fixture for signage applications, using a combination of a white light source and a plurality of primary color light sources.

FIG. 11 is a cross-sectional view of another example of a light emitting fixture for signage applications, in this case using a deflector and a combination of a white light source and a plurality of primary color light sources.

FIG. 12 is front view of a first example of a signage application using a diffusion chamber.

FIG. 13 is a cross-sectional view along the line A-A of FIG. 12.

FIG. 14 is a cross-sectional side view of a second example of a signage application using a diffusion chamber.

FIG. 15 is a cross-sectional top view of the second example of a signage application using a diffusion chamber.

FIG. 16 is an isometric view of a third example of a signage application using a diffusion chamber.

FIG. 17 is a cross-sectional side view of FIG. 16.

FIG. 18 is a cross-sectional view along the line B-B of FIG. 17.

### DETAILED DESCRIPTION

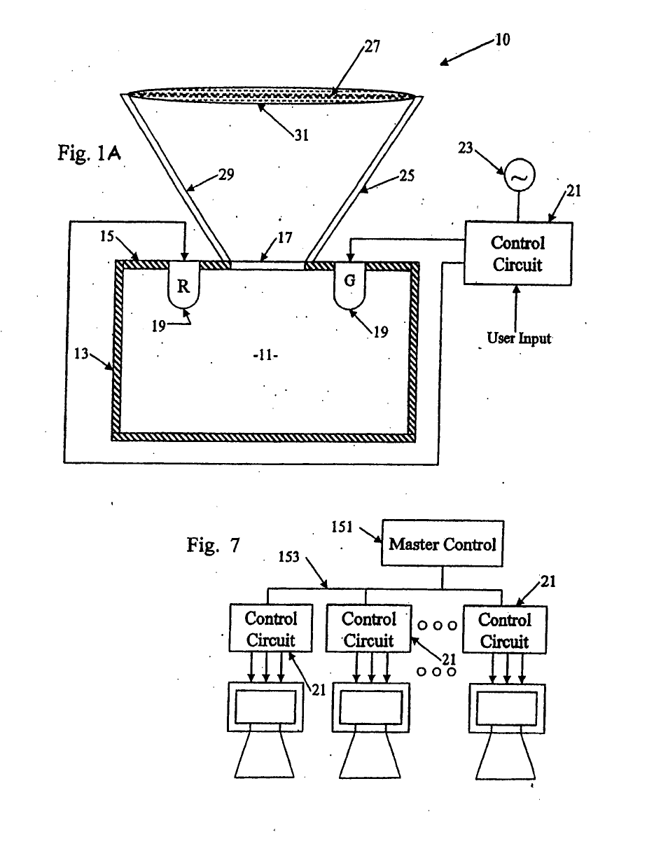

The examples discussed below are directed to signage systems wherein light is reflected diffusively. The signage systems disclosed herein include a diffusion chamber wherein the light emitted from the light source exhibits a diffuse reflectivity such that the light emerging from a signage system has uniform intensity and illumination. The surface of the interior of the diffusion chamber must have a highly efficient diffusely reflective characteristic, i.e., a reflectivity of over 90%, with respect to the visible wavelengths. The light sources include solid state light emitting elements such as LEDs or light emitting fixtures such as described below and illustrated in FIGS. 1A, 1B, 2 and 8-11 or any combination thereof.

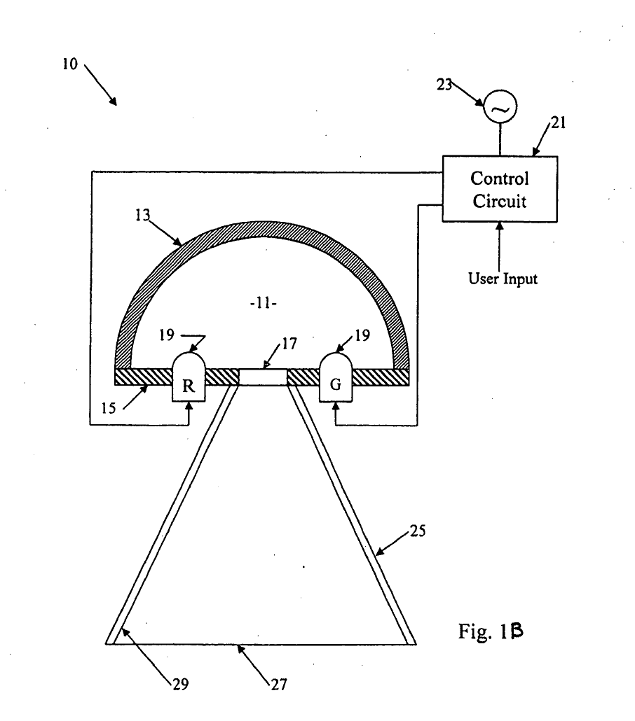

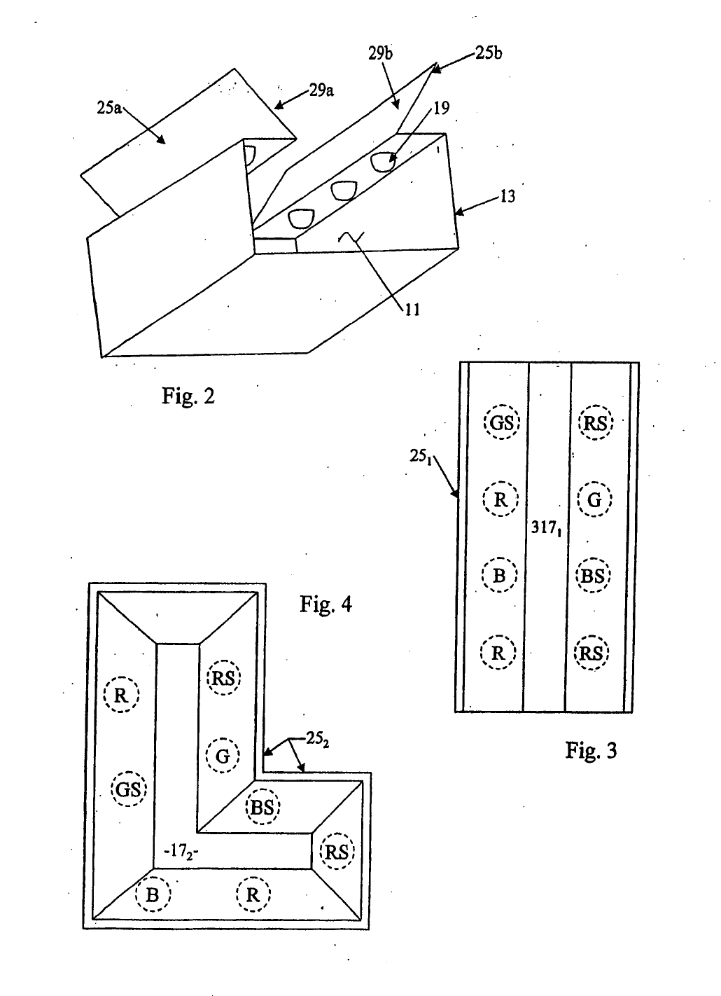

Each of FIGS. 1A and 1B is a cross-sectional illustrations of a radiant energy distribution light emitting fixtures 10. For signage applications, the fixture emits light in the visible spectrum. The illustrated fixture 10 includes an optical cavity 11 having a diffusely reflective interior surface, to receive and combine radiant energy of different colors or wavelengths. The optical cavity 11 may have various shapes. For example, the cavity may be substantially rectangular as shown in FIG. 1A or hemispherical or substantially semi-cylindrical as shown in FIG. 1B. FIG. 2 is an isometric view of a portion of a fixture having the cross-section of FIG. 1A, showing several of the components formed as a single extrusion of the desired cross section. FIGS. 3 and 4 show various structural configurations of the fixture.

At least a substantial portion of the interior surface(s) of the optical integrating cavity 11 exhibit(s) diffuse reflectivity. It is desirable that the cavity surface have a highly efficient reflective characteristic, e.g. a reflectivity equal to or greater than 90%, with respect to the relevant wavelengths. In the examples of FIGS. 1A and 1B, the surface is highly diffusely reflective to energy in the visible, near-infrared, and ultraviolet wavelengths.

The optical integrating cavity 11 may be formed of a diffusely reflective plastic material extruded in the desired shape. The surface of the interior of the optical cavity must have a highly efficient diffusely reflective characteristic, i.e., a reflectivity of over 90%, with respect to the visible wavelengths. One example of suitable material for the interior surface is a polypropylene having a 97% reflectivity and a diffuse reflective characteristic. Such a highly reflective polypropylene is available from Ferro Corporation—Specialty Plastics Group, Filled and Reinforced Plastics Division, in Evansville, Ind. Another example of a plastic material with a suitable reflectivity is SPECTRALON. Alternatively, the optical integrating cavity may comprise a rigid extruded body having an interior surface or a diffusely reflective coating layer formed on the interior surface of a body made of a metal or non-metallic material so as to provide the diffusely reflective interior surface of the optical integrating cavity. The coating layer can be a flat-white paint or white powder coat. A suitable paint might include a zinc-oxide based pigment, consisting essentially of an uncalcined zinc oxide and preferably containing a small amount of a dispersing agent. The pigment is mixed with an alkali metal silicate vehicle-binder, which preferably is a potassium silicate, to form the coating material. For more information regarding the exemplary paint, attention is directed to U.S. patent application Ser. No. 09/866,516, which was filed May 29, 2001, by Matthew Brown, which issued as U.S. Pat. No. 6,700,112 on Mar. 2, 2004.

For purposes of the discussion, assume that the light emitting fixture includes an extruded body. The rectangular section 13 of the body in FIG. 1A or the substantially hemispherical or substantially semi-cylindrical section 13 of the body in FIG. 1B has a diffusely reflective interior surface forming the cavity 11. The extruded body may be formed of a diffusely reflective plastic, or the body may be extruded of plastic or other materials and have a diffusely reflective coating or paint on the interior surface forming the cavity 11. As a result, the cavity 11 is an integrating type optical cavity.

The section 13 of FIGS. 1A and 1B include a wall 15. The wall 15 has an aperture 17 that is relatively transmissive with respect to the range of light wavelengths used for the particular sinage application, so as to allow for emission of combined radiant energy. In the examples, the aperture 17 is a passage through the approximate center of the wall 15, although the aperture may be at any other convenient location on the wall 15 or elsewhere on the section 13. Because of the diffuse reflectivity within the optical cavity 11, light within the cavity is integrated before passage out of the aperture 17. In the examples of FIGS. 1A and 1B, the fixture 10 is shown emitting the combined radiant energy upward through the aperture 17, for convenience. Also, the optical cavity 11 may have more than one aperture 17, for example, oriented to allow emission of integrated light in two or more different directions or regions, e.g. as required to represent a particular character or symbol or a number of such symbols in a signage arrangement.

The solid state light emitting elements used in the signage applications essentially include any of a wide range of solid state light emitting or generating devices formed from organic or inorganic semiconductor materials. Examples of solid state light emitting elements include semiconductor laser devices and the like. Many common examples of solid state lighting elements, however, are classified as different types of “light emitting diodes ” or “LEDs.” This exemplary class of solid state light emitting elements encompasses any and all types of semiconductor diode devices that are capable of receiving an electrical signal and producing a responsive output of electromagnetic energy. Thus, the term “LED” should be understood to include light emitting diodes of all types, light emitting polymers, organic diodes, and the like. LEDs may be individually packaged, as in the illustrated examples. Of course, LED based elements may be used that include a plurality of LEDs within one package, for example, multi-die LEDs that contain separately controllable red (R), green (G) and blue (B) LEDs within one package. Those skilled in the art will recognize that “LED” terminology does not restrict the source to any particular type of package for the LED type source. Such terms encompass LED elements that may be packaged or non-packaged, chip on board LEDs, surface mount LEDs, and any other configuration of the semiconductor diode element that emits light. Solid state lighting elements may include one or more phosphors and/or nanophosphors based upon quantum dots, which are integrated into elements of the package or light processing elements to convert at least some radiant energy to a different more desirable wavelength or range of wavelengths.

The color of light or other electromagnetic radiant energy relates to the frequency and wavelength of the radiant energy and/or to combinations of frequencies/wavelengths contained within the energy. Many of the examples relate to colors of light within the visible portion of the spectrum, although examples also are discussed that utilize or emit other energy.

It also should be appreciated that solid state light emitting elements may be configured to generate electromagnetic radiant energy having various bandwidths for a given spectrum (e.g. narrow bandwidth of a particular color, or broad bandwidth centered about a particular frequency or wavelength), and may use different configurations to achieve a given spectral characteristic. For example, one implementation of a white LED may utilize a number of dies that generate different primary colors which combine to form essentially white light. In another implementation, a white LED may utilize a semiconductor that generates light of a relatively narrow first spectrum in response to an electrical input signal, but the narrow first spectrum acts as a pump. The light from the semiconductor “pumps” a phosphor material contained in the LED package, which in turn radiates a different typically broader spectrum of light that appears relatively white to the human observer.

Some signage applications may use sources of the same type, that is to say a set of light sources that all produce electromagnetic energy of substantially the same spectral characteristic. Examples include light sources that are all white or that all emit one primary color of light. Some signage applications use similar light sources with somewhat different spectral outputs, e.g. those that emit white light of two different color temperatures. Other applications use light sources of two, three or more different types, that is to say light sources that produce electromagnetic energy of two, three or more different spectral characteristics. Many such examples include sources of visible red (R) light, visible green (G) light and visible blue (B) light. Controlled amounts of light from RGB sources can be combined to produce light of many other visible colors, including various temperatures of white light.

Hence, the fixture 10 also includes sources of radiant energy of different wavelengths. For example, in FIGS. 1A, 1B and 2, the sources are LEDs 19, two of which are visible in the illustrated cross-section. The LEDs 19 supply radiant energy into the interior of the optical cavity 11. As shown, the points of emission into the interior of the optical cavity are not directly visible through the aperture 17. Direct emissions from the light source are aimed toward a reflective surface of the cavity, so that the light diffusely reflects one or more times in the cavity before emerging through the aperture. At least two of the LEDs emit radiant energy of different wavelengths, e.g. Red (R) and Green (G). Additional LEDs of the same or different colors may be provided. The optical cavity 11 effectively integrates the energy of different wavelengths, so that the integrated or combined radiant energy emitted through the aperture 17 includes the light of all the various wavelengths in relative amounts substantially corresponding to the relative intensities of input into the cavity 11.

The light source LEDs 19 can include LEDs of any color or wavelength. Typically, an array of LEDs for a visible light application includes at least red, green, and blue LEDs. The integrating or mixing capability of the optical cavity 11 serves to project light of any color, including white light, by adjusting the intensity of the various sources coupled to the cavity. Hence, it is possible to control color rendering index (CRI), as well as color temperature. The fixture 10 works with the totality of light output from a family of LEDs 19. However, to provide color adjustment or variability, it is not necessary to control the output of individual LEDs, except as they contribute to the totality. For example, it is not necessary to modulate the LED outputs. Also, the distribution pattern of the individual LEDs and their emission points into the cavity are not significant. The LEDs 19 can be arranged in any manner to supply radiant energy within the optical integrated cavity, although it is preferred that direct view of the LEDs from outside the fixture is minimized or avoided.

In FIGS. 1A and 1B, light outputs of the LED sources 19 are coupled directly to the aperture 17 of the fixture at points on the interior of the optical cavity 11 to emit radiant energy directly into the interior of the cavity. The LEDs may be located to emit light at points on the interior wall of the section 13, although preferably such points would still be in regions out of the direct line of sight through the aperture 17. For ease of construction, however, the openings for the LEDs 19 are formed through the wall 15. On the wall 15, the aperture and LEDs may be at any convenient locations. In FIG. 1A, the LEDs are mounted along the length of the rectangular body. In FIG. 1B, the LEDs are mounted around the perimeter of the semihemispherical cavity or along the perimeter on each side of the semi-cylindrical cavity in line with the longitudinal axis of the semi-cylindrical cavity.

The fixture 10 in FIGS. 1A and 1B also includes a control circuit 21 coupled to the LEDs 19 for establishing output intensity of radiant energy of each of the LED sources. The control circuit 21 as shown in FIGS. 1A and 1B typically includes a power supply circuit coupled to a power source, shown as an AC power source 23. The control circuit 21 also includes an appropriate number of LED driver circuits for controlling the power applied to each of the individual LEDs 19 and thus the intensity of radiant energy supplied to the cavity 11 for each different wavelength. Control of the intensity of emission of the sources sets a spectral characteristic of the combined radiant energy emitted through the aperture 17 of the optical integrating cavity. The control circuit 21 may be responsive to a number of different control input signals, for example, to one or more user inputs as shown by the arrow in FIGS. 1A and 1B. Although not visible in these illustrations, feedback may also be provided.

The control circuit 21 controls the power provided to each of the LEDs 19. The optical cavity 11 effectively integrates the energy of different wavelengths, from the various LEDs 19, so that the integrated light energy emitted through the apertures 17 and 27 includes the radiant energy of all the various wavelengths. Control of the intensity of emission of the sources, by the control circuit 21, sets a spectral characteristic of the combined radiant energy emitted through the aperture 35. The control also activates one or more dormant LEDs, on an “as-needed” basis, when extra output of a particular wavelength or color is required in order to maintain the light output, color, color temperature, and/or thermal temperature. As discussed later with regard to an exemplary control circuit, the fixture 10 could have a color sensor coupled to provide feedback to the control circuit 21. The sensor could be within the cavity or the deflector or at an outside point illuminated by the integrated light from the fixture. The control may also be responsive to other sensors, such as a temperature sensor and/or an overall intensity sensor.

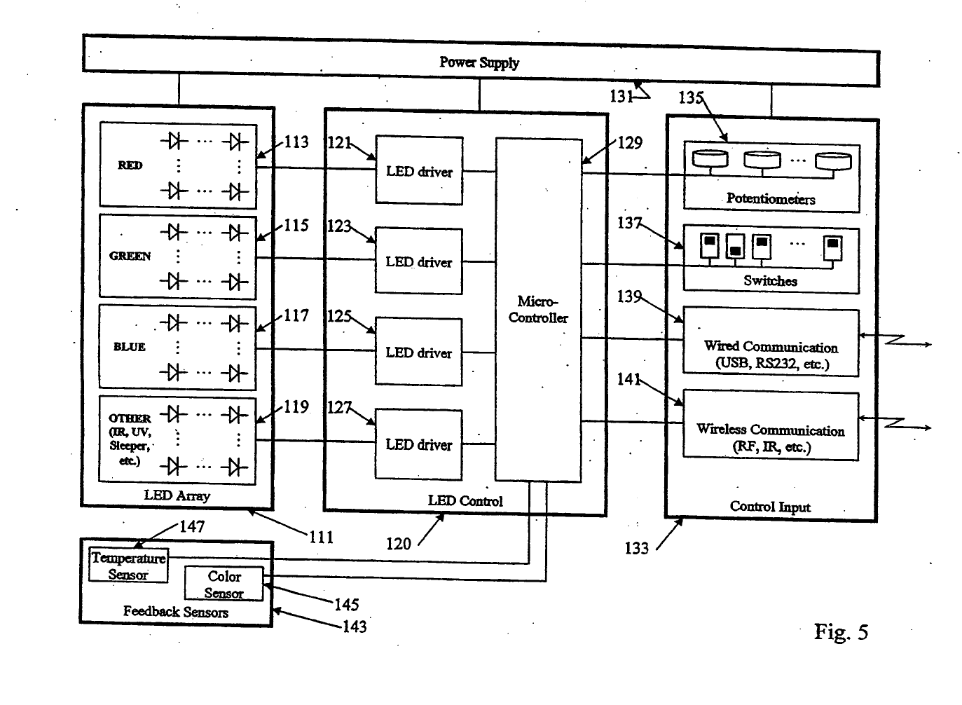

FIG. 5 is a block diagram of exemplary circuitry for the sources and associated control circuit, providing digital programmable control, which may be utilized with a light emitting fixtures of the types described above. In this circuit, the sources of radiant energy of the various types takes the form of an LED array 111. The array 111 comprises two or more LEDs of each of the three primary colors, red green and blue, represented by LED blocks 113, 115 and 117. For example, the array may comprise six red LEDs 113, three green LEDs 115 and three blue LEDs 117. The LED array in this example also includes a number of additional or “other” LEDs 119. There are several types of additional LEDs that are of particular interest in the present discussion. One type of additional LED provides one or more additional wavelengths of radiant energy for integration within the chamber. The additional wavelengths may be in the visible portion of the light spectrum, to allow a greater degree of color adjustment. Alternatively, the additional wavelength LEDs may provide energy in one or more wavelengths outside the visible spectrum, for example, in the infrared range or the ultraviolet range.

The electrical components shown in FIG. 5 also include an LED control system 120. The system 120 includes driver circuits for the various LEDs and a microcontroller. The driver circuits supply electrical current to the respective LEDs 113 to 119 to cause the LEDs to emit light. The driver circuit 121 drives the Red LEDs 113, the driver circuit 123 drives the green LEDs 115, and the driver circuit 125 drives the Blue LEDs 117. In a similar fashion, when active, the driver circuit 127 provides electrical current to the other LEDs 119. If the other LEDs provide another color of light, and are connected in series, there may be a single driver circuit 127. If the LEDs are sleepers, it may be desirable to provide a separate driver circuit 127 for each of the LEDs 119. The intensity of the emitted light of a given LED is proportional to the level of current supplied by the respective driver circuit.

The current output of each driver circuit is controlled by the higher level logic of the system. In this digital control example, that logic is implemented by a programmable microcontroller 129, although those skilled in the art will recognize that the logic could take other forms, such as discrete logic components, an application specific integrated circuit (ASIC), etc.

The LED driver circuits and the microcontroller 129 receive power from a power supply 131, which is connected to an appropriate power source (not separately shown). For most task-lighting applications, the power source will be an AC line current source, however, some applications may utilize DC power from a battery or the like. The power supply 129 converts the voltage and current from the source to the levels needed by the driver circuits 121-127 and the microcontroller 129.

A programmable microcontroller typically includes or has coupled thereto random-access memory (RAM) for storing data and read-only memory (ROM) and/or electrically erasable read only memory (EEROM) for storing control programming and any pre-defined operational parameters, such as pre-established light ‘recipes.’ The microcontroller 129 itself comprises registers and other components for implementing a central processing unit (CPU) and possibly an associated arithmetic logic unit. The CPU implements the program to process data in the desired manner and thereby generate desired control outputs.

The microcontroller 129 is programmed to control the LED driver circuits 121-127 to set the individual output intensities of the LEDs to desired levels, so that the combined light emitted from the aperture of the cavity has a desired spectral characteristic and a desired overall intensity. The microcontroller 129 may be programmed to essentially establish and maintain or preset a desired ‘recipe’ or mixture of the available wavelengths provided by the LEDs used in the particular system. The microcontroller 129 receives control inputs specifying the particular ‘recipe’ or mixture, as will be discussed below. To insure that the desired mixture is maintained, the microcontroller receives a color feedback signal from an appropriate color sensor. The microcontroller may also be responsive to a feedback signal from a temperature sensor, for example, in or near the optical integrating cavity.

The electrical system will also include one or more control inputs 133 for inputting information instructing the microcontroller 129 as to the desired operational settings. A number of different types of inputs may be used and several alternatives are illustrated for convenience. A given installation may include a selected one'or more of the illustrated control input mechanisms.

As one example, user inputs may take the form of a number of potentiometers 135. The number would typically correspond to the number of different light wavelengths provided by the particular LED array 111. The potentiometers 135 typically connect through one or more analog to digital conversion interfaces provided by the microcontroller 129 (or in associated circuitry). To set the parameters for the integrated light output, the user adjusts the potentiometers 135 to set the intensity for each color. The microcontroller 129 senses the input settings and controls the LED driver circuits accordingly, to set corresponding intensity levels for the LEDs providing the light of the various wavelengths.

Another user input implementation might utilize one or more dip switches 137. For example, there might be a series of such switches to input a code corresponding to one of a number of recipes. The memory used by the microcontroller 129 would store the necessary intensity levels for the different color LEDs in the array 111 for each recipe. Based on the input code, the microcontroller 129 retrieves the appropriate recipe from memory. Then, the microcontroller 129 controls the LED driver circuits 121-127 accordingly, to set corresponding intensity levels for the LEDs 113-119 providing the light of the various wavelengths. The microcontroller may also be programmed to cycle through a number of such recipes in sequence over time to provide a dynamic color changing routine.

As an alternative or in addition to the user input in the form of potentiometers 135 or dip switches 137, the microcontroller 129 may be responsive to control data supplied from a separate source or a remote source to select a recipe or to define or select a dynamic routine. For that purpose, some versions of the system will include one or more communication interfaces. One example of a general class of such interfaces is a wired interface 139. One type of wired interface typically enables communications to and/or from a personal computer or the like, typically within the premises in which the fixture operates. Examples of such local wired interfaces include USB, RS-232, and wire-type local area network (LAN) interfaces. Other wired interfaces, such as appropriate modems, might enable cable or telephone line communications with a remote computer, typically outside the premises. Other examples of data interfaces provide wireless communications, as represented by the interface 141 in the drawing. Wireless interfaces, for example, use radio frequency (RF) or infrared (IR) links. The wireless communications may be local on-premises communications, analogous to a wireless local area network (WLAN). Alternatively, the wireless communications may enable communication with a remote fixture outside the premises, using wireless links to a wide area network.

As noted above, the electrical components may also include one or more feedback sensors 143, to provide system performance measurements as feedback signals to the control logic, implemented in this example by the microcontroller 129. A variety of different sensors may be used, alone or in combination, for different applications. In the illustrated examples, the set 143 of feedback sensors includes a color sensor 145 and a temperature sensor 147. Although not shown, other sensors, such as an overall intensity sensor, may be used. The sensors are positioned in or around the system to measure the appropriate physical condition, e.g. temperature, color, intensity, etc.

The color sensor 145, for example, is coupled to detect color distribution in the integrated radiant energy. The color sensor may be coupled to sense energy within the optical integrating cavity 11, within the deflector 25 or at a point in the field illuminated by the particular system 10. However, in many cases, the wall 15 or another part of the rectangular section 13 may pass some of the integrated light from the cavity 11, in which case, it is actually sufficient to place the color light sensor(s) 145 adjacent any such partially transmissive point on the outer wall that forms the cavity.

Various examples of appropriate color sensors are known. For example, the color sensor may be a digital compatible sensor, of the type sold by TAOS, Inc. Another suitable sensor might use the quadrant light detector disclosed in U.S. Pat. No. 5,877,490, with appropriate color separation on the various light detector elements (see U.S. Pat. No. 5,914,487 for discussion of the color analysis).

The associated logic circuitry, responsive to the detected color distribution, controls the output intensity of the various LEDs, so as to provide a desired color distribution in the integrated radiant energy, in accord with appropriate settings. In an example using sleeper LEDs, the logic circuitry is responsive to the detected color distribution to selectively activate the inactive light emitting diodes as needed, to maintain the desired color distribution in the integrated radiant energy. The color sensor measures the color of the integrated radiant energy produced by the system and provides a color measurement signal to the microcontroller 129. If using the TAOS, Inc. color sensor, for example, the signal is a digital signal derived from a color to frequency conversion.

The temperature sensor 147 may be a simple thermoelectric transducer with an associated analog to digital converter, or a variety of other temperature detectors may be used. The temperature sensor is positioned on or inside of the fixture, typically at a point that is near the LEDs or other sources that produce most of the system heat. The temperature sensor 147 provides a signal representing the measured temperature to the microcontroller 129. The system logic, here implemented by the microcontroller 129, can adjust intensity of one or more of the LEDs in response to the sensed temperature, e.g. to reduce intensity of the source outputs to compensate for temperature increases. The program of the microcontroller 129, however, would typically manipulate the intensities of the various LEDs so as to maintain the desired color balance between the various wavelengths of light used in the system, even though it may vary the overall intensity with temperature. For example, if temperature is increasing due to increased drive current to the active LEDs (with increased age or heat), the controller may deactivate one or more of those LEDs and activate a corresponding number of the sleepers, since the newly activated sleeper(s) will provide similar output in response to lower current and thus produce less heat.

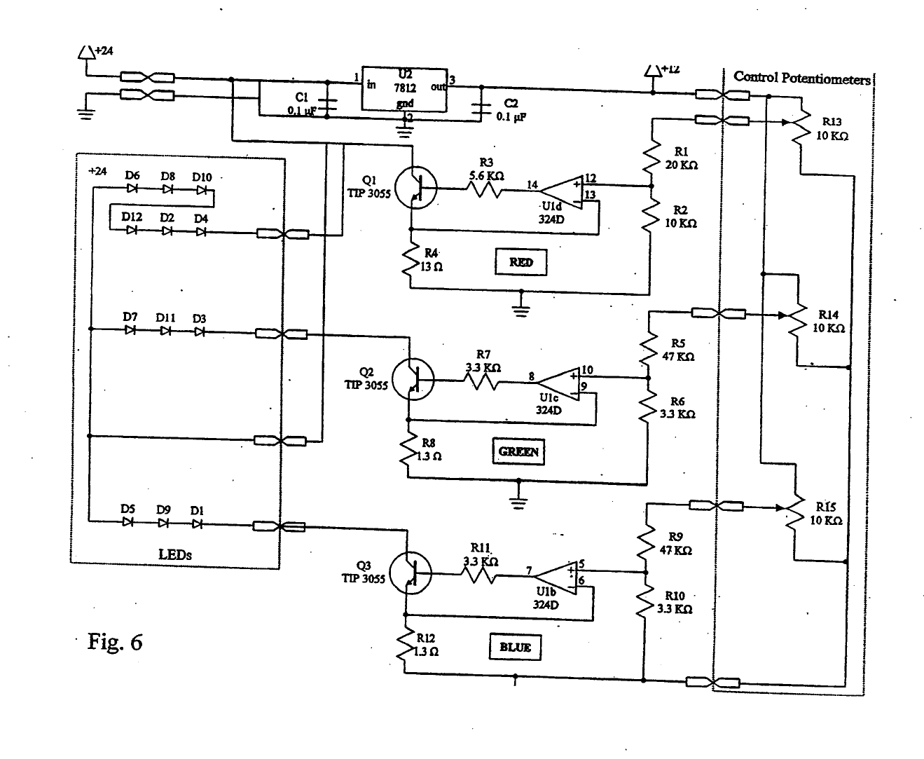

The above discussion of FIG. 5 related to programmed digital implementations of the control logic. Those skilled in the art will recognize that the control also may be implemented using analog circuitry. FIG. 6 is a circuit diagram of a simple analog control for a lighting apparatus (e.g. of the type shown in FIG. 1) using Red, Green and Blue LEDs. The user establishes the levels of intensity for each type of radiant energy emission (Red, Green or Blue) by operating a corresponding one of the potentiometers. The circuitry essentially comprises driver circuits for supplying adjustable power to two or three sets of LEDs (Red, Green and Blue) and analog logic circuitry for adjusting the output of each driver circuit in accord with the setting of a corresponding potentiometer. Additional potentiometers and associated circuits would be provided for additional colors of LEDs. Those skilled in the art should be able to implement the illustrated analog driver and control logic of FIG. 6 without further discussion.

The systems described above have a wide range of luminous applications, where there is a desire to set or adjust color provided by a lighting fixture. Some lighting applications involve a common overall control strategy for a number of the systems. As noted in the discussion of FIG. 5, the control circuitry may include a communication interface 139 or 141 allowing the microcontroller 129 to communicate with another processing system. FIG. 7 illustrates an example in which control circuits 21 of a number of the radiant energy generation systems with the light integrating and distribution type fixture communicate with a master control unit 151 via a communication network 153. The master control unit 151 typically is a programmable computer with an appropriate user interface, such as a personal computer or the like. The communication network 153 may be a LAN or a wide area network, of any desired type. The communications allow an operator to control the color and output intensity of all of the linked systems, for example to provide combined lighting effects from a number of fixtures that together spell our a word or phrase.

Automatic controls also are envisioned. For example, the control circuitry may include a data interface coupled to the logic circuitry, for receiving data defining the desired color distribution. Such an interface would allow input of control data from a separate or even remote fixture, such as a personal computer, personal digital assistant or the like. A number of the fixtures, with such data interfaces, may be controlled from a common central location or fixture.

The control may be somewhat static, e.g. set the desired color reference index or desired color temperature and the overall intensity, and leave the fixture set-up in that manner for an indefinite period. Also, light settings are easily recorded and reused at a later time or even at a different location using a different system.

The aperture 17 may serve as the system output, directing integrated color light to a desired area or region. Although not shown in this example, the aperture 17 may have a grate, lens or diffuser (e.g. a holographic element) to help distribute the output light and/or to close the aperture against entry of moisture of debris. The aperture 17 may have any shape desired to facilitate a particular luminance application and provide light passage for transmission of reflected and integrated light outward from the cavity 11.

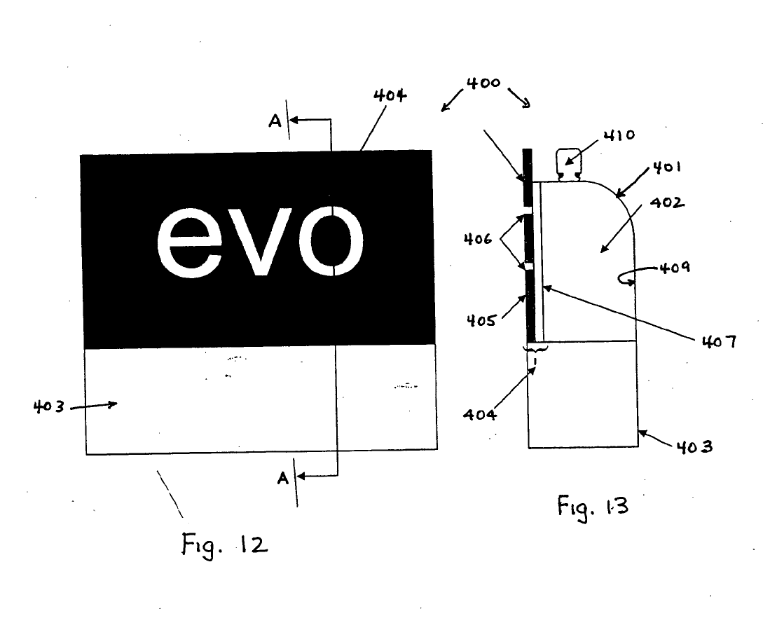

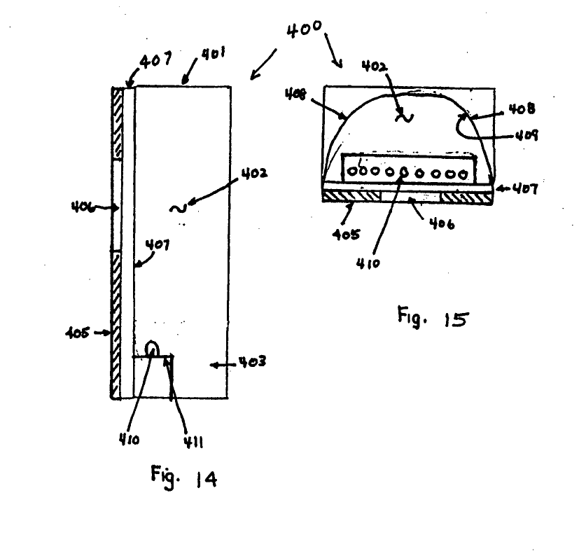

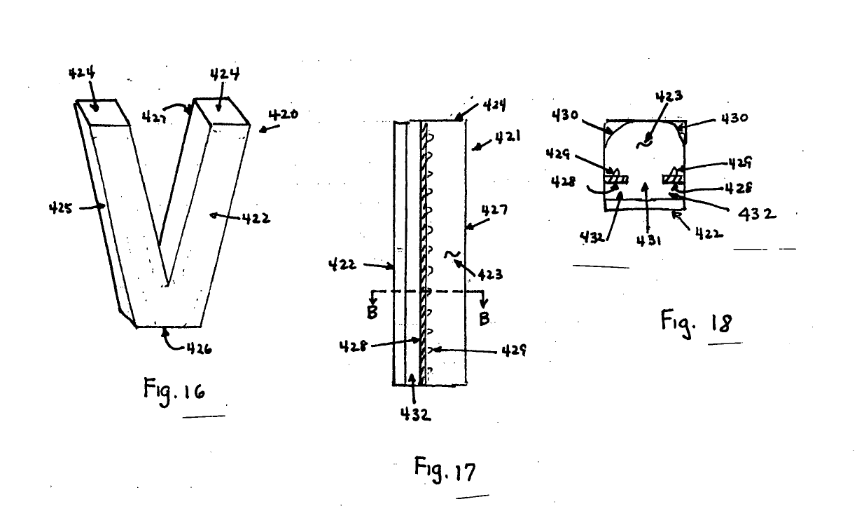

For signage applications, fixture 10 can include a reflective deflector 25 to further process and direct the light emitted from the aperture 17 of the optical cavity 11 into the diffusion chamber 402 (FIG. 12-15) and 423 (FIG. 16-18) of the signage housing. The deflector 25 has a reflective interior surface 29. When viewed in cross-section, the reflective portion of the deflector expands outward laterally from the aperture 17, as it extends away from the optical cavity 11 toward the region to be illuminated. In a circular implementation, the deflector 25 would be conical. However, in the example of FIG. 2, the deflector is formed by two opposing panels 25a and 25b of the extruded body. The inner surfaces 29a and 29b of the panels are reflective. All or portions of the deflector surfaces may be diffusely reflective, quasi-specular or specular. For some examples, it may be desirable to have one panel surface 29a diffusely reflective and have specular reflectivity on the other panel surface 29b.

As shown in FIGS. 1A and 1B, a small opening at a proximal end of the deflector 25 is coupled to the aperture 17 of the optical integrating cavity 11. The deflector 25 has a larger opening 27 at a distal end thereof. The angle of the interior surface 29 and size of the distal opening 27 of the deflector 25 define an angular field of radiant energy emission from the fixture 10. The large opening of the deflector 25 is transmissive, although it may be covered with a grating, a plate or the exemplary lens 31 (which is omitted from FIG. 2, for convenience). The lens 31 may be clear or translucent to provide a diffuse transmissive processing of the light passing out of the large opening. Prismatic materials, such as a sheet of microprism plastic or glass also may be used.

At least a substantial portion of the reflective interior surface 29 of the deflector 25 exhibits specular reflectivity with respect to the integrated radiant energy. As discussed in U.S. Pat. No. 6,007,225, for some applications, it may be desirable to construct the deflector 25 so that at least some portion(s) of the inner surface 29 exhibit diffuse reflectivity or exhibit a different degree of specular reflectivity (e.g., quasi-secular), so as to tailor the performance of the deflector 25 to the particular application. For other applications, it may also be desirable for the entire interior surface 29 of the deflector 25 to have a diffuse reflective characteristic.

In FIGS. 1A and 1B, the large distal opening 27 of the deflector 25 is roughly the same size as the cavity 11. In some applications, this size relationship may be convenient for construction purposes. However, a direct relationship in size of the distal end of the deflector and the cavity is not required. The large end of the deflector may be larger or smaller than the cavity structure. As a practical matter, the size of the cavity is optimized to provide the integration or combination of light colors from the desired number of LED sources 19. The size, angle and shape of the deflector 25 determine the area that will receive the luminous radiation from the combined or integrated light emitted from the cavity 11 emitted via the aperture 17.

Each light source of a particular wavelength comprises one or more LEDs. Within the diffusion chamber of the signage of the present invention, it is possible to process light received from any desirable number of such LEDs. Hence, the light sources may comprise one or more LEDs for emitting light of a first color, and one or more LEDs for emitting light of a second color, wherein the second color is different from the first color. In a similar fashion, the apparatus may include additional sources comprising one or more LEDs of a third color, a fourth color, etc. To achieve the highest color rendering index (CRI), the LED array may include LEDs of various wavelengths that cover virtually the entire visible spectrum. Examples with additional sources of substantially white light are discussed later.

Another type of LED array is the use of additional LEDs called sleeper LEDs. As LEDs age, they continue to operate, but at a reduced output level. The use of the sleeper LEDs greatly extends the lifecycle of the fixtures. Activating a sleeper (previously inactive) LED, for example, provides compensation for the decrease in output of the originally active LED. There is also more flexibility in the range of intensities that the fixtures may provide. Thus, some LEDs would be active, whereas the sleepers would be inactive, at least during initial operation. Using the circuitry of FIG. 5 as an example, the Red LEDs 113, Green LEDs 115 and Blue LEDs 117 might normally be active. The LEDs 119 would be sleeper LEDs, typically including one or more LEDs of each color used in the particular system.

FIGS. 3 and 4 depict use of initially inactive or “sleeper” LEDs. The array of LEDs 19 includes initially active LEDs for providing red (R), green (G) and blue (B) light. Specifically, there are two red (R) LEDs, one green (G) LED and one blue (B) LED. The array of LEDs 19 in these examples also includes sleeper LEDs of each type. The sleeper LEDs might include one Red sleeper (RS) LED, one Green sleeper (GS) LED and one Blue sleeper (BS) LED.

The third LED array type of interest is a white LED. For white luminous applications, one or more white LEDs provide increased intensity. The primary color LEDs then provide light for color adjustment and/or correction.

A deflector and a lens can be used to provide further optical processing of the integrated light emerging from the aperture 17 of the fixture. A variety of other optical processing fixtures may be used in place of or in combination with those optical processing elements. Examples include various types of diffusers, collimators, variable focus mechanisms, and iris or aperture size control mechanisms.

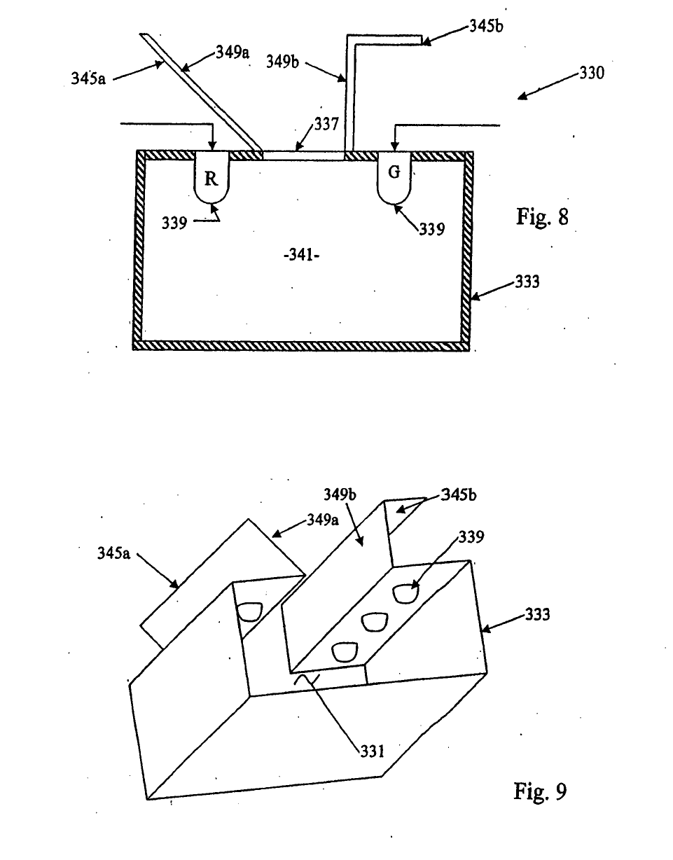

FIGS. 8 and 9 show another extruded type lighting fixture. The fixture 330 includes an optical integrating cavity 331 having a diffusely reflective inner surface, as in the earlier examples. In this fixture, the cavity 331 again has a substantially rectangular cross-section. FIG. 9 is an isometric view of a section of an extruded body member forming a portion of the fixture. The isometric view, for example, shows several of the components, particularly the rectangular section 333 and the deflector, formed as a single extrusion of the desired cross section, but without any end-caps.

As shown in these figures, the fixture 330 includes several initially-active LEDs and several sleeper LEDs, generally shown at 339, similar to those in the earlier examples. The LEDs emit controlled amounts of multiple colors of light into the optical integrating cavity 341 formed by the inner surfaces of a rectangular member 333. A power source and control circuit similar to those used in the earlier examples provide the drive currents for the LEDs 339, and in view of the similarity, the power source and control circuit are omitted from FIG. 8, to simplify the illustration. One or more apertures 337, of the shape desired to facilitate the particular lighting application, provide light passage for transmission of reflected and integrated light outward from the cavity 341.

The fixture 330 shown in FIG. 8 includes a deflector to further process and direct the light emitted from the aperture 337 of the optical integrating cavity 341, in this can somewhat to the left of and above the fixture 330 in the orientation shown. The deflector is formed by two opposing panels 345a and 345b of the extruded body of the fixture. The panel 345a is relatively flat and angled somewhat to the left, in the illustrated orientation. Assuming a vertical orientation of the fixture as shown in FIG. 8, the panel 345b extends vertically upward from the edge of the aperture 337 and is bent back at about 90° . The shapes and angles of the panels 345a and 345b are chosen to direct the light to a particular area to be illuminated.

Each panel 345a, 345b has a reflective interior surface 349a, 349b. As in the earlier examples, all or portions of the deflector surfaces may be diffusely reflective, quasi-specular or specular. In the example, the deflector panel surface 349b is diffusely reflective, and the deflector panel surface 349a has a specular reflectivity, to optimize distribution of emitted light over the desired area illuminated by the fixture 330. The output opening of the deflector 345 may be covered with a grating, a plate or lens, in a manner similar to the example of FIG. 1, although in the illustrated example (FIGS. 8 and 9), such an element is omitted.

Materials for construction of the cavity and the deflector and the types of LEDs that may be used are similar to those discussed relative to the example of FIGS. 1 and 2, although the number and intensities of the LEDs may be different, to achieve the output parameters desired for a particular application. The extruded body construction illustrated in FIGS. 8 and 9 may be curved or bent for use in different letters or numbers or other characters/symbols, as discussed above relative to FIGS. 1A, 1B and 2-4.

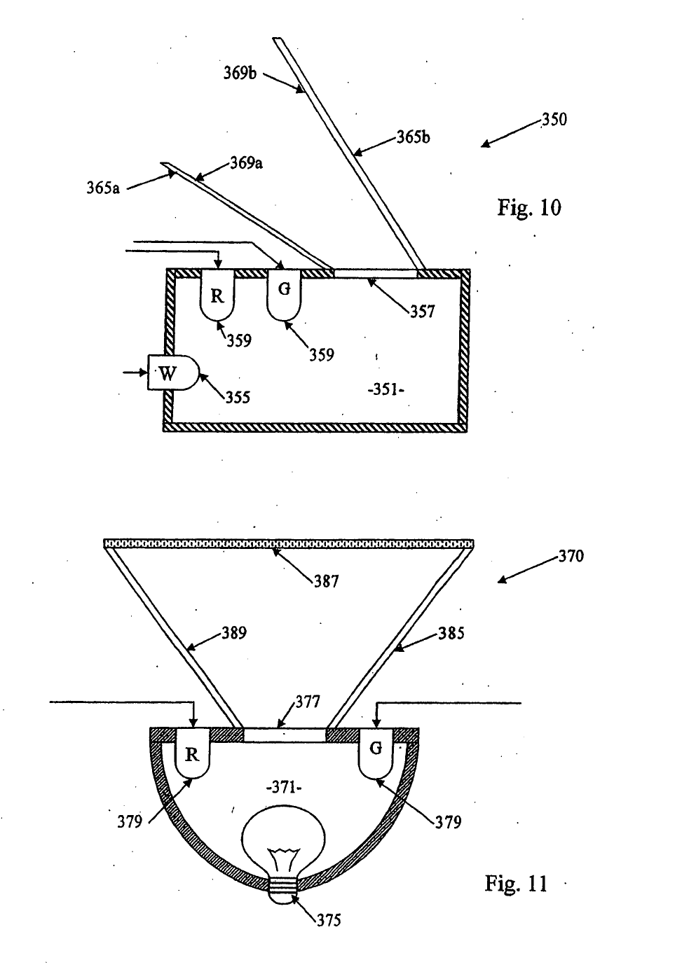

FIG. 10 is a cross sectional view of another example of an extruded construction of lighting fixture 350. The fixture 350 includes an optical integrating cavity 351 having a diffusely reflective inner surface, as in the earlier examples. In this fixture, the optical cavity 351 again has a substantially rectangular cross-section. As shown, the fixture 350 includes at least one white light source, represented by the white LED 355. The fixture also includes several LEDs 359 of the various primary colors, typically red (R), green (G) and blue (B, not visible in this cross-sectional view). The LEDs 359 include both initially-active LEDs and sleeper LEDs, and the LEDs 359 are similar to those in the earlier examples. Again, the LEDs emit controlled amounts of multiple colors of light into the optical integrating cavity 351 formed by the inner surfaces of a rectangular member 353. A power source and control circuit similar to those used in the earlier examples provide the drive currents for the LEDs 359, and in this example, that same circuit controls the drive current applied to the white LED 355. In view of the similarity, the power source and control circuit are omitted from FIG. 10, to simplify the illustration.

One or more apertures 357, of the shape desired to facilitate the particular lighting application, provide light passage for transmission of reflected and integrated light outward from the cavity 351. The aperture may be laterally centered, as in the earlier examples; however, in this example, the aperture is off-center to facilitate a light-throw to the left (in the illustrated orientation). Materials for construction of the cavity and the deflector and the types of LEDs that may be used are similar to those discussed relative to the earlier examples. Again, an extruded fixture of the illustrated cross section may be elongated, curved or bent, as desired to facilitate any desired application.

Here, it is assumed that the fixture 350 is intended to principally provide white light. The presence of the white light source 355 increases the intensity of white light that the fixture produces. The control of the outputs of the primary color LEDs 359 allows the operator to correct for any variations of the white light from the light source 355 from normal white light and/or to adjust the color balance/temperature of the light output. For example, if the white light source 355 is an LED as shown, the white light it provides tends to be rather blue. The intensities of light output from the LEDs 359 can be adjusted to compensate for this blueness, for example, to provide a light output approximating sunlight or light from a common incandescent source, as or when desired.

The fixture 350 may have any desired output processing element(s), as discussed above with regard to various earlier examples. In the illustrated embodiment of FIG. 10, the fixture 350 includes a deflector to further process and direct the light emitted from the aperture 357 of the optical integrating cavity 351, in this case somewhat toward the left of and above the fixture 350. The deflector is formed by two opposing panels 365a and 365b having reflective inner surfaces 365a and 365b. Although other shapes may be used to direct the light output to the desired area or region, the illustration shows the panel 365a, 365b as relatively flat panels set at somewhat different angle extending to the left, in the illustrated orientation. Of course, as for all the examples, the fixture may be turned at any desired angle or orientation to direct the light to a particular region from which a person will observe its luminance or to an object or person to be illuminated by the fixture, in a given application.

As noted, each panel 365a, 365b has a reflective interior surface 369a, 369b. As in the earlier examples, all or portions of the deflector surfaces may be diffusely reflective, quasi-specular or specular. In the example, the deflector panel surface 369b is diffusely reflective, and the deflector panel surface 369a has a specular reflectivity, to optimize distribution of emitted light over the desired region intended to receive light from the fixture 350. The output opening of the deflector 365 may be covered with a grating, a plate or lens, in a manner similar to the example of FIG. 1, although in FIG. 10, such an element is omitted.

The extruded body construction illustrated in FIG. 10 may be curved or bent for use in different letters or numbers or other characters/symbols, as discussed above relative to FIGS. 1-4.

FIG. 11 is a cross-sectional view of another example of an optical integrating cavity type light fixture 370. This example uses a deflector and lens to optically process the light output, and like the example of FIG. 10 the fixture 370 includes LEDs to produce various colors of light in combination with a white light source. The fixture 370 includes an optical integrating cavity 371, having a semi-circular cross-section. The fixture may be approximately hemispherical, or the fixture 370 may be elongated. The extruded body construction illustrated in FIG. 11 may be curved or bent for use in the signage embodiments of the present invention so that the LED's are not visible to the observer.

The surfaces of the extruded body forming the interior surface(s) of the cavity 371 are diffusely reflective. One or more apertures 377 provide a light passage for transmission of reflected and integrated light outward from the optical cavity 371. Materials, sizes, orientation, positions and possible shapes for the elements forming the cavity and the types/numbers of LEDs have been discussed above.

As shown, the fixture 370 includes at least one white light source. Although the white light source could comprise one or more LEDs, as in the previous embodiment fixture shown in FIG. 10, in this embodiment, the white light source comprises a lamp 375. The lamp may be any convenient form of light bulb, such as an incandescent or fluorescent light bulb; and there may be one, two or more bulbs to produce a desired amount of white light. A preferred example of the lamp 375 is a quartz halogen light bulb. The fixture also includes several LEDs 379 of the various primary colors, typically red (R), green (G) and blue (B, not visible in this cross-sectional view), although additional colors may be provided or other color LEDs may be substituted for the RGB LEDs. Some LEDs will be active from initial operation. Other LEDs may be held in reserve as sleepers. The LEDs 379 are similar to those in the earlier examples, for emitting controlled amounts of multiple colors of light into the optical integrating cavity 371.

A power source and control circuit similar to those used in the earlier fixture embodiments provide the drive currents for the LEDs 359. In view of the similarity, the power source and control circuit for the LEDs are omitted from FIG. 11, to simplify the illustration. The lamp 375 may be controlled by the same or similar circuitry, or the lamp may have a fixed power source.

The white light source 375 may be positioned at a point that is not directly visible through the aperture 377 similar to the positions of the LEDs 379. However, for applications requiring relatively high white light output intensity, it may be preferable to position the white light source 375 to emit a substantial portion of its light output directly through the aperture 377.

The fixture 370 may incorporate any of a number of the further optical processing elements as discussed in the above incorporated U.S. Pat. No. 6,995,355. In the illustrated version, however, the fixture 370 includes a deflector 385 to further process and direct the light emitted from the aperture 377 of the optical integrating cavity 371. The deflector 385 has a reflective interior surface 389 and expands outward laterally from the aperture, as it extends away from the cavity toward the region to be illuminated. In a circular implementation, the deflector 385 would be conical. Of course, for applications using other fixture shapes, the deflector may be formed by two or more panels of desired sizes and shapes, e.g. as in FIGS. 1, 2 and 8-10. The interior surface 389 of the deflector 385 is reflective. As in the earlier examples, all or portions of the reflective deflector surface(s) may be diffusely reflective, quasi-specular, specular or combinations thereof.

As shown in FIG. 11, a small opening at a proximal end of the deflector 385 is coupled to the aperture 377 of the optical integrating cavity 311. The deflector 385 has a larger opening at a distal end thereof. The angle of the interior surface 389 and size of the distal opening of the deflector 385 define an angular field of radiant energy emission from the apparatus 370.

The large opening of the deflector 385 is covered with a grating, a plate or the exemplary lens 387. The lens 387 may be clear or translucent to provide a diffuse transmissive processing of the light passing out of the large opening. Prismatic materials, such as a sheet of microprism plastic or glass also may be used. In applications where a person may look directly at the fixture 370 from the illuminated region, it is preferable to use a translucent material for the lens 387, to shield the observer from directly viewing the lamp 375.

The fixture 370 thus includes a deflector 385 and lens 387, for optical processing of the integrated light emerging from the optical cavity 371 via the aperture 377. Of course, other optical processing elements may be used in place of or in combination with the deflector 385 and/or the lens 387.

In the fixture of FIG. 11, the lamp 375 provides substantially white light of relatively high intensity. The integration of the light from the LEDs 379 in the cavity 375 supplements the light from the lamp 375 with additional colors, and the amounts of the different colors of light from the LEDs can be precisely controlled. Control of the light added from the LEDs can provide color correction and/or adjustment, as discussed above relative to the embodiment of FIG. 10.

As shown by the discussion above, each of the various radiant energy emission systems with multiple color sources and an optical cavity to combine the energy from the sources provides a highly effective means to control the color produced by one or more fixtures. The output color characteristics are controlled simply by controlling the intensity of each of the sources supplying radiant energy to the chamber.

Settings for a desirable color are easily reused or transferred from one system/fixture to another. If color/temperature/balance offered by particular settings are found desirable, e.g. to provide special effects lighting on signage displayed at a number of different locations, it is a simple matter to record those settings from operation of one sign and apply them to similar fixtures forming signs at the other locations.

The methods for defining and transferring set conditions can utilize manual recordings of settings and input of the settings to the different lighting systems. However, it is preferred to utilize digital control, in systems such as described above relative to FIGS. 10 and 11. Once input to a given lighting system, a particular set of parameters for a product or individual become another ‘preset’ lighting recipe stored in digital memory, which can be quickly and easily recalled and used each time that the particular product or person is to be illuminated.

FIGS. 12-18 illustrate the signage embodiments. FIGS. 12 and 13 illustrate the one example of the signage system. FIG. 12 shows front view of the sign 400 while FIG. 13 is a cross-sectional view of the sign of FIG. 12 along line A-A. The sign comprises a sign housing 401, which includes a diffusion chamber 402 and a base portion 403. A sign panel 404 transmissive to visible light is on the front side of housing 401. The sign panel comprises a mask of opaque material 405 of little or no light transmissivity such as aluminum or any other opaque material, having an opening 406 therein, that is not opaque to visible light. For purposes of this invention, “an opening” or “the opening” means one or more optical openings in the sign panel, that is at least substantially transmissive with respect to radian electromagnetic energy of the relevant wavelengths. The opening is configured such that when light passes through it, it conveys information for ad content or the like to the observer. The opening 406 can define a letter or group of letters, a cut out image, a symbol or group of symbols or other such designs or information to be advertised. In the embodiment of FIG. 12, the panel has two optical apertures in the shape of the letters “EVO.” The sign panel 404 can optionally include sheet 407 of a clear or substantially transparent material (shown in FIG. 13) such as a clear acrylic to protect the optical cavity 402 and the base portion 403 from deleterious elements of the environment, such as rain, wind, snow and dust. For complex cut out shapes, the sheet 407 may also support portions of the mask. For example, a thin mask material having openings therein to define an advertisement can be coated or laminated onto transparent sheet 407. The backside of the mask may be reflective.

Opposite the sign panel at the rear of the housing 401 is a diffusely reflective interior surface 409 made of a diffuse reflective material as described above. This material is usually white, but it could be any color depending on the advertising scheme. The reflective interior surface can be a layer of diffuse reflective material coated or laminated on the interior walls of the housing forming the diffusion chamber or it can be a separate reflector 408 in the diffusion chamber having a diffusely reflective interior surface 409 as shown in FIG. 15 of the second embodiment of the invention. As shown in the second embodiment, the reflector 408 can be semi-cylindrical in shape.

Light is introduced into the diffusion chamber 402 from one or an array of light sources 410. The light source 410 can be one or more LED's or one or more light emitting fixtures like those illustrated in FIGS. 1A, 1B, 2-4 and 8-11 or any combination thereof or any of a number of other optical integrating fixture arrangements as disclosed in U.S. Pat. No. 6,995,355, which is incorporated herein by reference. The LED's and/or light emitting fixtures can be mounted anywhere to supply light inside the housing 401 provided the fixtures themselves are not visible to an observer viewing the sign from the front or the side or through the opening in the panel. In the example shown in FIGS. 12 and 13, a light source 410 is located at the top of the diffusion chamber 402 and can be a light emitting fixture comprising a substantially semi-cylindrical optical cavity having a plurality of LEDs along the periphery of the semi-cylindrical optical cavity in line with the longitudinal axis of the cavity. In another embodiment shown in FIGS. 14 and 15, light sources are located in the base 403 of the sign housing 401. In that example, the light emitting fixtures or individual LEDs are mounted on a shelf 411 in the base portion 403 of housing 401. Light from light sources 410 are reflected off the diffusely reflective interior surface 409 so that light from the sources is mixed.

The light sources can be arranged in an array or groups of arrays. For example, the light sources can be arranged such that each fixture includes a first source of a first color or wavelength of radiant energy and a second source of a second color or wavelength of radiant energy different from said first color or wavelength so that the light emitted from said first and second sources is combined and emerges into the diffusion cavity and is diffusively reflected off the reflective interior surfaces in the diffusion chamber. Also, a plurality of light sources, each emitting a different color or wavelength of radiant energy can be used or groups of light emitting fixtures, each emitting a different color or wavelength of light can be employed. Light from the light sources reflect one or more times in the diffusion chamber 402. At least one reflection of light from each source or fixture is diffusely reflected off surface 409. Such reflections optically confine the light in diffusion chamber.

As used in this disclosure, the term “diffuse reflectivity” and “diffusely reflected” mean that light is reflected light that forms a relatively uniform distribution of light and light intensity within the diffusion chamber. The opening 406 allows the diffusely reflected light from the diffusion chamber 402 to reach the openings 406 and exit the sign panel 404 to the observer.

In still another embodiment, the sign includes a channel sign 420 such as illustrated in FIGS. 16-18. This sign can be a letter or a symbol. The channel sign comprises a housing 421 having a light transmissive sign panel 422, which is made of a material that is substantially transparent or translucent to visible light, and top panel 424, side panel 425, bottom panel 426 and rear panel 427, each of which is made of a material that is opaque to visible light such as aluminum or any other material which is opaque to visible light. The housing panels form a diffusion chamber 423. Within the diffusion chamber are shelves 428, which are attached to the inside perimeter of the body, that is the side, bottom and/or top panels of the housing.

As illustrated in FIG. 18, the interior surface of the housing 421 has a reflector 430 having a semi-cylindrical shape. The reflector 430 is either made of or is a substrate coated with a diffuse reflective material as previously described. As an alternative, the interior surfaces of the panels 424, 425, 426 and 427 can be coated or have laminated thereto the diffuse reflective material. In this way, the diffusion chamber forms an optical integrating cavity, in a manner similar to the cavities in the embodiments of FIGS. 1A, 1B, 2-4 and 8-11.

Light sources 429 can be fixtures such as LED's or the fixtures illustrated in FIGS. 1A, 1B, 2-4 and 8-11 are attached to shelves 428. The light emitting fixtures face the reflector or the rear panel of the body. The space 431 between the shelves allows the light from the diffusion chamber 423 to reach the front of the sign panel 422 of the body and can be observed through the sign panel.

The shelves are spaced apart from the front and rear panels of the body. The recess 432 of the shelves 428 from the front panel 422 allows light to diffuse reflectively, i.e., to uniformly distribute light over the entire area behind the sign panel. As described previously described in the first and second embodiments, the light sources in the third embodiment can be similarly arranged in an array or groups of arrays.

The embodiments of the signage illustrated in FIGS. 12-18 can further include, as described above, the controller to couple a plurality of light sources so as to control amount of visible light from the fixtures and to control color of illumination within the diffusion chamber. Further, the sign can include three or more light sources emitting different colors or wavelengths of light. Control of the light emissions from the light sources allows setting and variation of the combined light formed in the diffusion chamber. The combined light provides a corresponding color illumination of the signage information via the openings in the sign panel or light transmissive front panel of the channel symbol. In addition to the above, the signage embodiments of the invention can employ inactive or “sleeper” LED's as previously described.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A sign comprising:
a diffusion chamber having a reflective interior surface, at least a portion of which exhibits a diffuse reflectivity;
at least one light source within the diffusion chamber for generating visible light, each light source supplying visible light to enter the diffusion chamber in such a manner that substantially all light emitted from each light source reflects diffusely at least once within the diffusion chamber; and
a sign panel transmissive to visible light coupled to the diffusion chamber;
wherein the diffusion chamber is configured to provide reflection of light having uniform intensity and illumination for emission through the sign panel and wherein the light sources are located so as not to be directly observable through the sign panel.

2. The sign according to claim 1, wherein there is a plurality of said light sources, each emitting different colors of light that optically combine and reflect diffusively from the reflective interior surface and emerge as combined light through the sign panel.

3. The sign according to claim 1, wherein there is a plurality of said light sources, each source emitting the same color of light that optically combine and reflect diffusively from said reflective surface and emerge as combined light of the same color through the sign panel.

4. The sign according to claim 1, wherein said at least one light source comprises a light emitting diode.

5. The sign according to claim 1, wherein the at least one light source comprises:
a body having an optical cavity, said optical cavity having a diffusely reflective surface;
a light emitting aperture optically coupled to the diffusion chamber; and
a solid state light emitting element within the optical cavity to supply light into the optical cavity.

6. The sign according to claim 5, wherein the light fixture further includes a deflector having a diffusively reflective surface optically coupling the light emitting aperture to the diffusion chamber.

7. The sign according to claim 6, wherein the reflective interior surface of the diffusion chamber is diffusely reflective.

8. The sign according to claim 5, wherein the solid state light emitting element is a light emitting diode.

9. The sign of claim 1, further comprising a controller coupled to at least one light source to control amount of visible light emitted from said at least one light emitting fixture to control color of illumination within the diffusion cavity.

10. The sign of claim 1, wherein
the diffusion chamber is behind the sign panel and the reflective interior surface is opposite the sign panel and is diffusely reflective; and
each of the light sources is coupled to supply light into the diffusion chamber from a point on a lateral surface of cavity.

11. The sign of claim 1, wherein light from at least one light source is reflected off said diffusely reflective surface to uniformly distribute light in said diffusion chamber.

12. The sign of claim 1, wherein the light source comprises at least one initially active solid state element and at least one sleeper solid state element.

13. The sign of claim 1, wherein the sign panel comprises a substrate having high trasnmissivity to visible light, a mask having low transmissivity to visible light; and an opening in the mask through which light from the diffusion chamber emerges.

14. A sign for conveying information comprising:
a sign panel having a mask having low transmissivity to visible light;
an opening formed through the mask, the opening having a substantially higher transmissivity to visible light and having a shape to present information content to an observer of the sign panel;
a diffusion chamber formed behind a rear face of the sign panel, the chamber having an interior which is at least substantially reflective to visible light, a portion of an interior surface of the chamber opposite the opening exhibiting a substantially diffuse reflectivity with respect to visible light;
at least one light source comprising a body having an optical cavity, an optical aperture, a first light emitting element generating a first color of visible light and second light emitting element generating a second color of light different from the first color; wherein the first and second colors of light are combined in the optical integrating cavity, the combined light emerging from the optical cavity and into the interior of the diffusion chamber through the optical aperture, the diffusively reflected light from the diffusion chamber emerging through the opening in the mask; and
a controller coupled to the first and second light emitting sources to control amount of color of visible light from the first and second light emitting elements emerging through the opening so as to control the color of illumination.

15. The sign of claim 14, wherein the sign panel further comprises the mask coupled to a substantially transparent substrate having high transmissivity to visible light.

16. A sign comprising:
a body having a sign panel and a diffusion chamber having a reflective interior surface in the body, at least a portion of the chamber exhibits a diffuse reflectivity;
a shelf along a portion of a perimeter of the body and spaced from the sign panel and from the reflective interior surface; and
a plurality of light sources for generating visible light, each light source coupled to the shelf and facing the reflective interior surface and supplying visible light to enter the diffusion chamber in such a manner that substantially all light emitted from each light source reflects diffusely at least once within the diffusion chamber;
wherein the diffusion chamber is configured to supply the combined light for emission through the clear front panel and the light sources are not directly observable through the clear front panel.

17. The sign of claim 16, wherein the body comprises aluminum.

18. The sign of claim 16, wherein the shelf is coated with a diffusively reflective material.

19. The sign according to claim 16, wherein the at least one light source comprises a light emitting diode.

20. The sign according to claim 16, wherein the at least one light source comprises:
a body having an optical cavity, said optical cavity having a diffusely reflective surface;
a light emitting aperture coupled to the diffusion chamber; and
a solid state light emitting element within the body to supply light into the optical cavity.

21. The sign according to claim 20, wherein the light fixture further includes a deflector having a diffusively reflective surface providing an optical coupling of the apterture to the diffusion chamber.
